(19) United States
(12) Patent Application Publication
(10) Pub. No.: US 2026/0119396 A1
(43) Pub. Date: Apr. 30, 2026

(54) EFFICIENT CACHE MAINTENANCE FOR A TABLE HAVING AN OPEN TABLE FORMAT

(71) Applicant: Teradata US, Inc, San Diego, CA (US)

(72) Inventors: K N Sai Krishna Rangavajjula, Guntur Dt. (IN); Chandrasekhar Tekur, Hyderabad (IN); Shambhu Sree Vegunta, Hyderabad (IN); Bhargav Reddi, Vizianagaram (IN); Diwakar Mishra, Hyderabad (IN)

(73) Assignee: Teradata US, Inc, San Diego, CA (US)

(21) Appl. No.: 18/927,624

(22) Filed: Oct. 25, 2024

(51) Int. Cl. G06F 12/0802; G06F 16/22; G06F 16/2455

(52) U.S. Cl. CPC G06F 12/0802; G06F 16/2282; G06F 16/24552

(57) ABSTRACT

A method, apparatus, and computer program product for executing a relational database management system (RDBMS) in a computer system, wherein the RDBMS manages a relational database storing data in a table having an open table format (OTF). The RDBMS maintains a cache for the data stored in the table, and determines whether the cache is stale using metadata for the table that is stored in the cache. The RDBMS incrementally updates the cache when the cache is stale.

### PRIOR ART

This invention relates to methods and techniques for efficient cache maintenance for a table having an Open Table Format (OTF).

### BACKGROUND OF THE INVENTION

Computer systems implementing a relational database management system (RDBMS) are well known in the art. An RDBMS stores data as tables in a relational database comprised of objects containing rows and rows containing columns, and uses a data description language (DDL), a data manipulation language (DML), and a structured query language (SQL), to define, create, modify and access the data.

There is a growing trend to leverage Open Table Format (OTF), such as Apache™ Iceberg™, Delta Lake™, Hudi™, etc., for use with tables stored in relational databases. A table using OTF is typically organized or structured as files (Parquet™, for example) along with appropriate metadata captured for efficient file filtering.

OTF provides wrappers around the table, wherein OTF uses one or more files to:
Track schema and partitions using DDL changes on a table's files.
Track the table's files and column statistics for the table.
Track all the inserts, updates and deletes using DML on the table.

OTF stores a chronological series of files for the table, which enables:
Schema and partition evolution.
Travelling back in time to a previous table state.
Creating metadata for the table state.
Handling multiple reads and writes concurrently.

Typically, an OTF is an open source, standardized format that provides a layer of abstraction over large databases, such as data lakes comprised of structured, semistructured, and unstructured data, and introduces database-like functionalities for managing large databases efficiently.

There are a number of challenges involved in cache maintenance and usage for an OTF table. Generally, update and delete operations on an OTF table generate entries in delete files, using a merge-on-read (MOR) approach, which include data file names and row offsets to streamline these operations. However, existing cache maintenance methods necessitate reading all data linked with the table irrespective of the extent to which the data has been altered. Such methods are resource-intensive and lack efficiency.

Specifically, existing cache maintenance methods lack the ability to utilize valid rows in the cache:
In scenarios where data resides in a cloud-based store and is subject to concurrent modifications by multiple writers, cache management becomes complex.
Presently, even minor updates or deletions trigger an update of the snapshot identifiers and timestamps for OTF tables, rendering the entire cache obsolete.
Pinpointing only those rows that have become stale while preserving most of the unaltered cache could significantly boost query performance and reduce costs.

On the other hand, improved cache maintenance methods could provide incremental cache maintenance:
For enhanced query performance and reduced redundancy in processing, an incremental model for maintaining caches is advocated.
The incremental model would selectively refresh only those parts of the cache affected by modifications, rather than overhauling the cache entirely after each operation.

Thus, there is a need in the art for optimization techniques for cache operations on relational databases storing tables having an OTF, especially incremental cache maintenance. The present invention satisfies this need.

### SUMMARY OF THE INVENTION

A method, apparatus, and computer program product for executing an RDBMS in a computer system, wherein the RDBMS manages a relational database storing data in a table having an OTF. The RDBMS maintains a cache for the data stored in the table, and determines whether the cache is stale using metadata for the table that is stored in the cache. The RDBMS incrementally updates the cache when the cache is stale.

### BRIEF DESCRIPTION OF DRAWINGS

Referring now to the drawings in which like reference numbers represent corresponding parts throughout:

FIG. 1 illustrates an exemplary hardware and software environment, according to one embodiment of the present invention.

FIG. 2 illustrates the steps or functions performed by the RDBMS when processing a query.

FIG. 3 is a block diagram that illustrates an OTF structure for a table.

FIG. 4 illustrates the steps or functions performed by the RDBMS using the OTF structure for a table.

FIG. 5 is a block diagram that illustrates a cache structure, according to one embodiment of the present invention.

FIG. 6 illustrates the steps or functions performed by the RDBMS when processing a query using the cache structure of FIG. 5.

### DETAILED DESCRIPTION OF THE INVENTION

In the following description of the preferred embodiment, reference is made to the accompanying drawings, which form a part hereof, and in which is shown by way of illustration a specific embodiment in which the invention may be practiced. It is to be understood that other embodiments may be utilized, and structural changes may be made without departing from the scope of the present invention.

### Overview

This invention maintains a cache for data stored in one or more OTF tables in a cloud-based store, detects the staleness of data stored in the cache, and incrementally maintains the cache, which avoids processing unmodified data repeatedly during every cache maintenance iteration.

Unlike existing mechanisms, this invention efficiently identifies whether portions of the cached data are not stale, even though metadata indicates that the cached data has been modified (e.g., cached data that is not of interest may have been updated or deleted). If the cached data is stale (because the cached data that is of interest has been modified or new data has been inserted), this invention identifies only those portions of the cached data that need to be read and updated in the cache, by storing metadata in the cache.

### Hardware and Software Environment

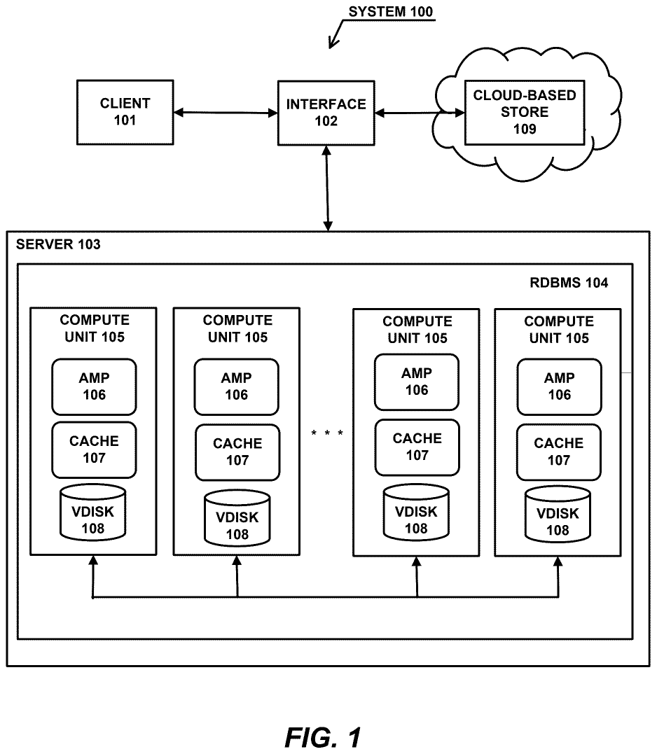

FIG. 1 illustrates an exemplary hardware and software environment according to one embodiment of the present invention. In the exemplary environment, a computer system 100 implements a data warehouse in a three-tier client-server architecture, wherein the first or client tier provides clients 101 that may include, inter alia, a graphical user interface (GUI), the second or middle tier provides an interface 102 for interfacing with the data warehouse, and the third or server tier comprises the data warehouse executed by the server 103, which is a Relational DataBase Management System (RDBMS) 104 that stores data and metadata in a relational database. The first, second, and third tiers may be implemented in separate computers, or may be implemented as separate or related processes in a single computer.

In the preferred embodiment, the RDBMS 104 is executed by one or more compute units 105, e.g., processors, in the computer system 100, wherein the RDBMS 104 manages a relational database comprised of one or more tables stored on one or more data storage devices connected to the computer system 100. In one embodiment, the computer system 100 is comprised of one or more access module processors (AMPs) 106 performing the functions of the RDBMS 104, one or more caches 107 storing local data for the RDBMS 104, and one or more virtual disks (VDISKs) 108 storing the relational database of the RDBMS 104. The AMPs 106, caches 107 and VDISKs 108 may be implemented in separate processors, or may be implemented as separate or related processes in a single processor.

The RDBMS 104 used in the preferred embodiment comprises the Teradata® Vantage® RDBMS sold by Teradata™ US, Inc., the assignee of the present invention, although other DBMS's could be used. In this regard, Teradata® Vantage® RDBMS is a hardware and software based data warehousing/analytic application/database system.

Generally, operators or users of the system 100 interact with the clients 101 to formulate a workload comprised of one or more queries for the RDBMS 104, wherein the requests are transmitted via the interface 102 to the RDBMS 104, and responses are received therefrom. The RDBMS 104 performs the workload comprised of one or more queries against a relational database comprised of one or more tables storing data. Specifically, the RDBMS 104 performs the functions described below, including accepting the workload comprised of the queries, generating one or more query execution plans (QEPs) from the queries, and then performing the query execution plans to process data retrieved from the tables. Moreover, the results from these functions may be provided directly to clients 101, or may be provided to other systems, such as a cloud-based store 109, by the interface 102, or may be stored by the RDBMS 104 in the relational database.

In one or more embodiments, the cloud-based store 109 stores one or more objects, such as one or more datasets storing data. The cloud-based store 109 may be a distributed native object store (NOS), such as AWS™ or other S3™ compatible systems, Microsoft™ Azure™, Google™ Cloud™, etc., or a distributed file system, such as a Hadoop Distributed File System (HDFS). The RDBMS 104 may retrieve the data from the objects in the cloud-based store 109, wherein the data is then stored in the relational database for use by the RDBMS 104 in processing queries.

Note that, in one or more embodiments, the system 100 may use any number of different parallelism mechanisms to take advantage of the parallelism offered by the multiple tier architecture, the client-server structure of the client 101, interface 102, RDBMS 104, and cloud-based store 109, as well as the multiple compute nodes 105, AMPs 106, caches 107 and VDISKs 108. Further, data within the relational database may be partitioned across the compute units 105, AMPs 106, caches 107 and VDISKs 108 to provide additional parallelism.

In one embodiment, each of the compute units 105 manages a portion of the database that is stored in a corresponding one of the caches 107 and/or VDISKs 108, which may be sourced from one or more objects in the cloud-based store 109. For example, the rows and/or columns of tables stored in the caches 107 and/or VDISKs 108 may be partitioned across the compute units 105 to ensure that workloads are distributed evenly across the compute nodes 105. The RDBMS 104 organizes the storage of data and the distribution of rows and/or columns of tables among the compute nodes 105. The RDBMS 104 also coordinates the execution of the query execution plans by the AMPs 106, and the retrieval of data from the caches 107 and/or VDISKs 108, in response to the queries received from the clients 101.

Generally, the clients 101, interface 102, RDBMS 104, compute units 105, AMPs 106, caches 107, VDISKs 108, and cloud-based store 109, comprise hardware and/or software, including logic and/or data tangibly embodied in and/or accessible from a device, media, or carrier, such as RAM, ROM, one or more of the data storage devices, and/or a remote system or device communicating with the computer system 100 via one or more data communications devices. The above elements 101-109 and/or operating instructions may also be tangibly embodied in memory and/or data communications devices, thereby making a computer program product or article of manufacture according to the invention. As such, the terms “article of manufacture,” “program storage device” and “computer program product” as used herein are intended to encompass a computer program accessible from any computer readable device, media or carrier. Accordingly, such articles of manufacture are readable by a computer and embody at least one program of instructions executable by a computer to perform various method steps of the invention.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

### Query Processing

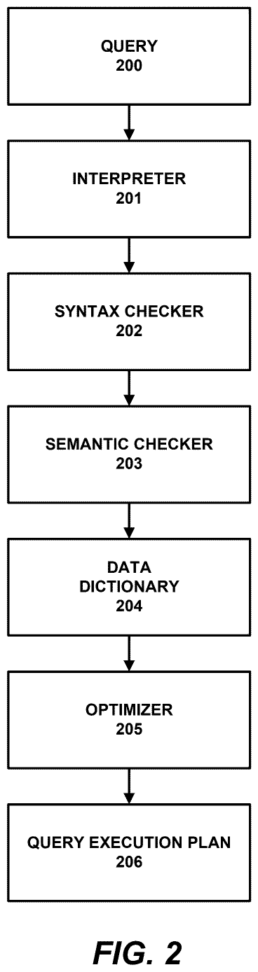

FIG. 2 illustrates the steps or functions performed by the RDBMS 104 when processing a query 200, which typically comprises one or more data manipulation language (DML) statements, such as an SQL query. An interpreter 201 interprets the query 200, a syntax checker 202 checks the query 200 for proper syntax, a semantic checker 203 evaluates the query 200 semantically, and consults a data dictionary 204 to ensure that all of the objects specified in the query 200 actually exist and that the user has the authority to perform the query 200. Finally, an optimizer 205 selects one or more query execution plans 206 for the query 200 based on cost profiles, in order to execute an optimal query execution plan 206 for the query 200. To address concerns regarding the cost involved in processing the query 200, data is often stored locally in the cache 107 and/or VDISKS 108 at the compute unit 105 having an AMP 106 performing the query execution plan 205, so that subsequent queries 200 can make use of the cache 107 to improve query 200 performance.

### OTF Table

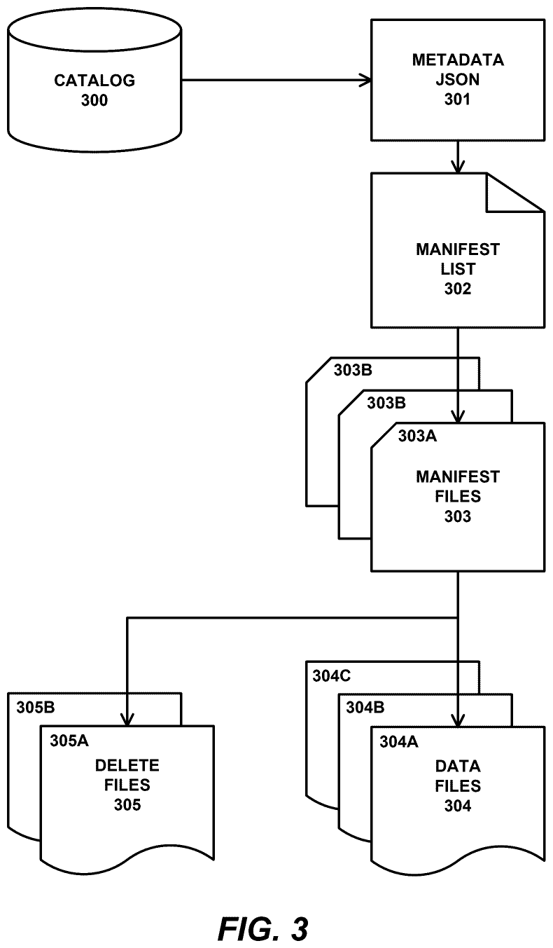

FIG. 3 is a block diagram that illustrates an OTF table initially stored in the cloud-based store 109, and subsequently retrieved from the cloud-based store 109 and stored in the relational database. In one embodiment, the OTF comprises Apache™ Iceberg™, although other OTFs could be used as well. Apache™ Iceberg™ is a high-performance, open table format that has rapidly become a standard for tables used in large-scale analytics.

In this example, a Catalog 300 managed by the RDBMS 104 stores snapshot identifiers to snapshots for the OTF table associated with different timestamps, including a current snapshot identifier, wherein each snapshot is comprised of a Metadata JSON 301, Manifest List 302, Manifest Files 303, Data Files 304 and Delete Files 305 that represents the state of the table at a particular period of time. The Catalog 300 snapshot identifiers are used to access a complete set of Metadata JSON 301, Manifest List 302, Manifest Files 303, Data Files 304 and Delete Files 305 for the table.

The table's state at each snapshot is maintained by the Metadata JSON 301, which acts as a centralized source for all data and metadata related to the table at a particular point in time. JSON (JavaScript Object Notation) is a lightweight data-interchange format comprised of a collection of name/value pairs realized as columns, rows, objects, etc. The Metadata JSON 301 comprises metadata that tracks the table's schema definitions, partition configurations, custom properties, snapshot identifier and its associated timestamp, etc. The Metadata JSON 301 identifies the Manifest List 302, which is a list of all the Manifest Files 303, and the Manifest Files 303 identify the associated Data Files 304 and/or Delete Files 305. The Metadata JSON 301, Manifest List 302, Manifest Files 303, Data Files 304 and Delete Files 305 are not static but evolve with the table.

The Manifest Files 303 track the Data Files 304 and Delete Files 305 in each snapshot, and contain a row for each Data File 304 and Delete File 305 in the table, as well as metadata for the Data Files 304 and Delete Files 305. The metadata is used to avoid reading the Data Files 304 and Delete Files 305 that are not required for an operation. The snapshot is the union of all Data Files 304 and Delete Files 305 in the Manifest Files 303 at a particular timestamp. The Manifest Files 303 may be reused across snapshots to avoid rewriting the Data Files 304 and Delete Files 305 that are slow-changing.

The Manifest List 302 tracks the Manifest Files 303 for each snapshot. The Manifest List 302 stores metadata about the Manifest Files 303, as well as the Data Files 304 and Delete Files 305. The metadata is used to avoid reading the Manifest Files 303, Data Files 304 and Delete Files 305 that are not required for an operation.

The Data Files 304 contain the current data associated with the table and the Delete Files 305 track any update or delete operations made to the Data Files 304:
When the table is created and the initial data is inserted into the table, the RDBMS 104 creates at least one Data File 304A and stores the initial data in the Data File 304A.
When inserting a new row into the table, the RDBMS 104 creates at least one new Data File 304B and stores the new row in the Data File 304B.
When deleting an existing row from the table, the RDBMS 104 marks the existing row as deleted in a Delete File 305A, which also stores the file name and the row offset for the deleted row in the Data Files 304A, 304B, but the Data Files 304A, 304B are not changed.
When updating an existing row in the table, the RDBMS 104 marks the existing row as deleted in a Delete File 305B, which also stores the file name and row offset for the deleted row in the Data Files 304A, 304B, and inserts a new row into the table by creating a new Data File 304C.
When reading a row from the table, the RDBMS 104 will first access the Delete Files 305A, 305B to determine whether the row has been deleted, as indicated by the file name and the row offset for the deleted row in the Data Files 304A, 304B 304C. Only if the row has not been deleted, will the RDBMS 104 access the row from the Data Files 304A, 304B, 304C.

The Manifest Files 303A, 303B, 303C, Manifest List 302, and Metadata JSON 301 are similarly updated by the RDBMS 104 in response to data being inserted, updated or deleted using the Data Files 304 and Delete Files 305.

As can be seen, Apache™ Iceberg™ provides easy access to table-specific information such as a table's history, snapshots, and other metadata. The metadata can be very helpful in providing a detailed overview of all the operations performed on the table. Moreover, the Metadata JSON 301, Manifest List 302, Manifest Files 303, Data Files 304 and Delete Files 305 can be queried directly by the RDBMS 104.

### OTF Table Steps or Functions

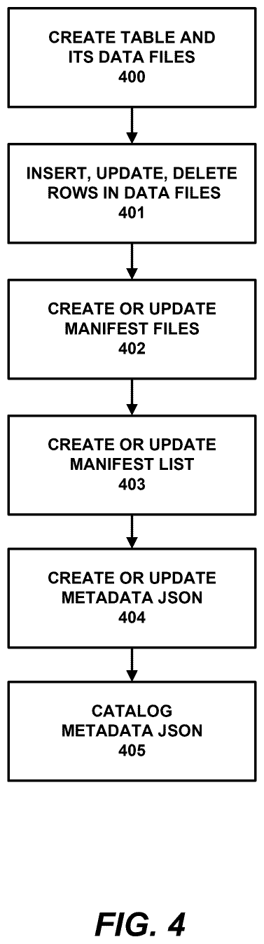

FIG. 4 illustrates the steps or functions performed by the RDBMS 104 on the OTF table.

Block 400 represents the step or function of creating a table T1 and its associated Data Files 304 that are loaded into the cloud-based store 109, for example, by the RDBMS 104 executing the following command:

CREATE TABLE T1 (A INT, B VARCHAR(10), C FLOAT, D DATE);

This command creates a table T1 that is comprised of 4 columns, namely, column A that contains integer values, column B that contains character data up to a maximum of 10 characters, column C that contains floating point values, and column D that contains dates.

Block 401 represents the steps or functions performed by the RDBMS 104 of inserting, updating and/or deleting rows in and/or from the Data Files 304 and/or Delete Files 305 for the table. For example, the following command results in the RDBMS 104 inserting the initial data from local-table into the table T1 and its associated Data Files 304 created by Block 400:

INSERT T1 (SELECT * FROM local-table);

Block 402 represents the step or function of the RDBMS 104 creating and/or updating the Manifest Files 303 for the Data Files 304.

Block 403 represents the step or function of the RDBMS 104 creating and/or updating the Manifest List 302 for the Manifest Files 303.

Block 404 represents the step or function of the RDBMS 104 creating and/or updating the Metadata JSON 301 for the Manifest List 302.

Block 405 represents the step or function of the RDBMS 104 inserting a current snapshot identifier for the updated Metadata JSON 301 into the Catalog 300.

In these steps or functions, the RDBMS 104 writes rows to the Data Files 304 and Delete Files 305 for the table, and updates metadata in the Data Files 304 and Delete Files 305, Manifest Files 303, Manifest List 302, Metadata JSON 301, and Catalog 300.

### Cache Structure

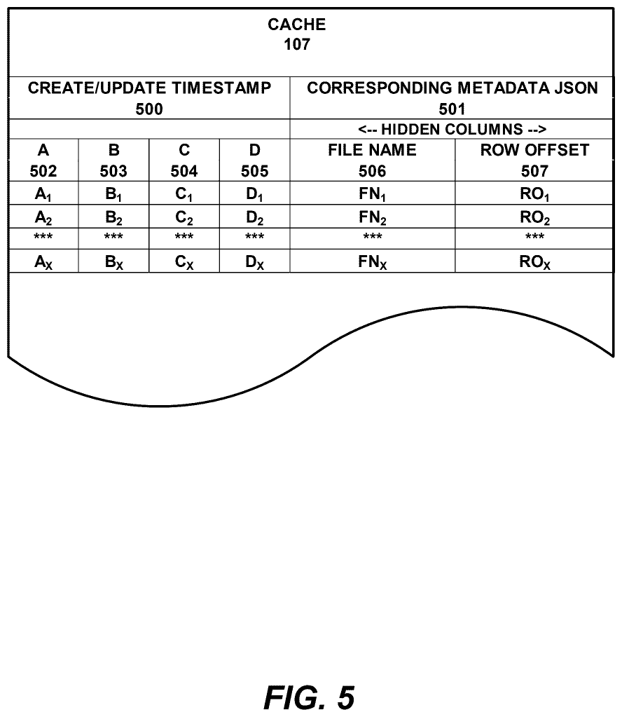

FIG. 5 is a block diagram that illustrates the structure of a cache 107 for an OTF table in one embodiment, although other structures could be used as well. The cache 107 stores metadata for the OTF table, including a header comprised of a Create/Update Timestamp 500 and a Corresponding Metadata JSON 301, which is a snapshot identifier. Each entry in the cache 107 includes one or more columns of the table, in this example, columns A 502, B 503, C 504 and D 505, and their associated values A1, A2, . . . , Ax, B1, B2, . . . , Bx, C1, C2, . . . , Cx, D1, D2, . . . , Dx, as well as metadata for the table comprising hidden columns, in this example, File Name 506, Row Offset 507 and their columns values FN1, FN2, . . . , FNx, RO1, RO2, . . . , ROx.

### Cache Operation

This invention uses metadata information, such as a Delete File 305 (which contains the file name of a Data File 304 and a row offset in the Data File 304 corresponding to a row that has been deleted from the Data File 304), to efficiently maintain the cache 107.

Consider an OTF table that contains 1 billion rows stored into 1 million Data Files 304. As noted above, for every update or delete operation on an existing row in the table, the RDBMS 104 marks the existing row as deleted in a Delete File 305B, which also stores the file name and row offset for the deleted row in the Data Files 304A, 304B; in the case of an update operation, the RDBMS 104 also inserts a new row into the table by creating a new Data File 304C. Thus, any subsequent read operation on the OTF table needs to scan the Delete Files 305 to determine if a row has been updated or deleted.

In the cache 107 for the table, the Corresponding Metadata JSON 501 is compared to the current snapshot identifier for the Metadata JSON 301, and the Create/Update Timestamp 500 is compared to the timestamp for the Metadata JSON 301, to determine whether the cache 107 is stale or not. Any update or delete operation, e.g., impacting a subset of rows out of all of the rows, would modify the current snapshot identifier for the Metadata JSON 301 and/or the timestamp for the Metadata JSON 301.

In existing cache 107 maintenance approaches, irrespective of the amount of data modified, the entire data associated with the table would need to be read to maintain the cache 107 (although the data could be filtered based on a predicate if available). Thus, maintenance of the cache 107 is highly inefficient and costly in existing approaches.

In the context of this invention, the hidden columns of File Name 506 and Row Offset 507 are maintained by the cache 107, and read operations by the RDBMS 104 accessing the Delete Files 305 can easily determine whether a row identified by the File Name 506 of the Data File 304 at the specified Row Offset 507 has been impacted by update or update operation(s), and thereafter use the cache 107, if the row has not been updated or deleted.

As noted above, an operation by the RDBMS 104 could be an insert, update or delete operation. The following describes how the cache 107 is maintained with each of these operations:
Insert: A new Data File 304 is always generated and a corresponding entry in the cache 107 may be created.
Update (e.g., delete and insert): All the current rows that are to be updated across various Data Files 304 are stored in the Delete Files 305, and updated rows are written to new Data Files 304. The RDBMS 104 can look up the entries in the Delete File 305 (optionally using a bloom filter in the metadata indicating whether a column value is present in a row), and check if there are relevant entries present in the cache 107. If relevant entries are present in the cache 107, then the RDBMS 104 can skip the entries in cache 107 and read the Data Files 304; otherwise, it would consider the entries in the cache 107. A corresponding entry in the cache 107 may be updated after reading the Data File 304.
Delete: Only Delete Files 305 are written and no new Data Files 304 are created. The RDBMS 104 can look up the entries in the Delete File 305 (optionally using a bloom filter in the metadata indicating whether a column value is present in a row), and determine whether there are corresponding entries in the cache 107. If corresponding entries are present in the cache 107, then the RDBMS 104 can delete the entries in cache 107; otherwise, it would consider the entries in the cache 107.

During subsequent reads, by looking at the Create/Update Timestamp 500 when the cache 107 was created or last maintained, and comparing the Corresponding Metadata JSON 501 to the current snapshot identifier for the Metadata JSON 301, only those new Data Files 304 created later than the Create/Update Timestamp 500 need to be scanned and the cache 107 updated accordingly.

### Cache Steps or Functions

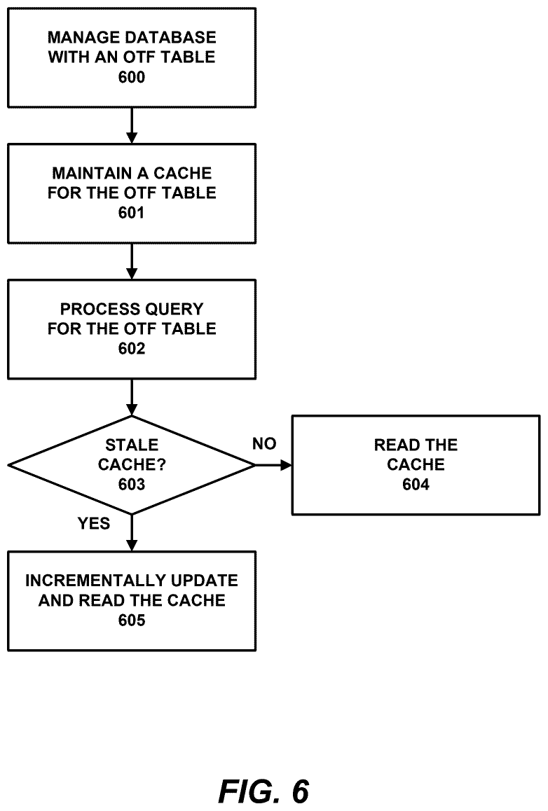

FIG. 6 illustrates the steps or functions performed by the RDBMS 104 when processing a query 200 using the cache 107.

Block 600 represents the step or function of the RDBMS 104 managing a relational database storing data in a table having an open table format (OTF).

Block 601 represents the step or function of the RDBMS 104 maintaining a cache 107 for the data stored in the table.

Block 602 represents the step or function of the RDBMS 104 processing a query 200 for the data stored in the table.

Block 603 represents the step or function of the RDBMS determining whether the cache 107 is stale when processing the query using metadata for the table that is stored in the cache 107. If not, Block 604 is performed; otherwise, Block 605 is performed.

Generally, the RDBMS 104 compares the metadata stored in the cache 107 to the metadata for the table to determine whether the cache 107 is stale, wherein the metadata for the table is modified by any write operation to the table.

Specifically, the metadata stored in the cache 107 includes a Create/Update Timestamp 500 that is stored in the cache 107 identifying when the cache 107 was created or last updated, and a Corresponding Metadata JSON 501 that is stored in the cache 107 that comprises a snapshot identifier to the Metadata JSON 301 for the table. The RDBMS 104 determines whether the cache 107 is stale when the Create/Update Timestamp 500 stored in the cache 107 is older than a timestamp associated with the current snapshot identified for the Metadata JSON 301, and/or when the Corresponding Metadata JSON 501 stored in the cache 107 is not a current snapshot identifier for the Metadata JSON 301.

If the Create/Update Timestamp 500 and/or Corresponding Metadata JSON 501 indicate that the cache 107 is stale, the RDBMS 104 will next determine whether desired entries in the cache 107 are stale. The metadata for the table that is stored in the cache 107 also comprises a File Name 506 and a Row Offset 507 associated with each entry stored in the cache 107. The File Name 506 identifies a Data File 304 associated with the entry stored in the cache 107 and the Row Offset 507 identifies a row in the Data File 304 associated with the entry stored in the cache 107, and the RDBMS 104 updates the entry stored in the cache 107 using the File Name 506 and the Row Offset 507 that identifies the row in the Data File 304 associated with the entry stored in the cache 107.

The RDBMS 104 determines that the desired entry stored in the cache is stale using a Delete File 305 that contains the File Name 506 and the Row Offset 507, and the Delete File 305 indicates that the row in the Data File 304 has been updated in or deleted from the Data File. The entry in the cache 107 is updated or deleted when the Delete File 305 indicates that the row in the Data File 304 has been updated or deleted. The Delete File 305 may also contain a bloom filter indicating whether a column value is present in the row.

As noted above, only the Delete File 305 is created but no new data file is created, when the row is deleted from the Data File 304; the Delete File 305 and a new Data File 304 are created, when the row is updated in the Data File 304; and a new Data File 304 is created, when the row is inserted in the Data File 304.

Block 604 represents the step or function of the RDBMS 104 reading the data from the cache 107 to process the query when the cache is not stale.

Block 605 represents the step or function of the RDBMS incrementally updating the cache 107 when the cache 107 is stale, and the RDBMS 104 reading the data from the cache 107 to process the query when the cache is incrementally updated. Moreover, the RDBMS 104 may trigger an asynchronous cache maintenance task after the RDBMS 104 deletes or updates data in the table.

### Modifications and Alternatives

As noted above, a bloom filter (metadata information indicating whether a column value is present in a row) could be generated for a Delete File 305 when reading it for the first time (with an identifying hash generated on the File Name 506 of the Data File 304 and the Row Offset 507 within the Data File 304), and stored in the cache 107, so that subsequent references to the entries of the Delete File 305 during reads (to check if there is a relevant cache 107 entry) provide for quick lookups, improving performance further.

Also, if the metadata information, such as partition information or column level information, available in the Manifest Files 303 with relevant timestamps (greater than the Create/Update Timestamp 500 associated with the cache 107) could be used as well to decide whether reading the Delete Files 305 is needed. After the RDBMS 104 updates the OTF table, it could trigger an asynchronous cache 107 maintenance task.

With regard to cache 107 maintenance, information from the Delete Files 305 indicate which Data Files 304 have been updated and/or deleted, and the corresponding row offsets. Since the cache 107 also contains the File Names 506 of the Data Files 304 and the Row Offsets 507 in the Data Files 304, the cache 107 entry can be deleted if its corresponding File Name 506 and Row Offset 507 pair is found in the Delete File 305. For a newly inserted Data File 304 in the cloud-based store 109, the qualified rows are populated in the cache 107 when read by the RDBMS 104. To avoid additional overhead of cache 107 maintenance when read by the RDBMS 104, the RDBMS 104 can trigger a background process that performs cache 107 maintenance.

A query 200 with snapshot isolation using an expected timestamp can read from the cache 107 without worrying about stale data, if the last Create/Update Timestamp 500 of the cache 107 is within the expected timestamp of the query 200. If the read is serializable, then the Create/Update Timestamp 500 of the cache 107 is checked and the OTF table is read if the cache 107 does not qualify.

### Advantages and Benefits

This invention has the following advantages and benefits:
Efficient cache updates:

This solution ensures that unmodified data remains untouched, and only cache entries corresponding to modified rows are refreshed.

This selectivity prevents unnecessary reprocessing of unchanged data.
Improved query performance because of cache usability:

Cache staleness is identified precisely, and in the case of staleness, the cache is maintained efficiently.
Reduced latency:

When a small portion of the data is modified, the cache can quickly identify the affected rows using the hidden columns and Delete File entries.

Users experience faster query responses due to reduced cache update time and reuse of unaffected portions of the cache reduces query latency and cost.

### Cost Savings:

Incremental cache maintenance minimizes unnecessary processing, as only impacted cache entries are updated, thereby saving computational resources and associated costs.

Avoiding full cache rebuilds for minor changes contributes to overall cost-effectiveness, such as reducing accesses of the cloud-based store.

### Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A computer-implemented method, comprising:
executing a database management system (RDBMS) in a computer system, wherein:
the RDBMS manages a relational database storing data in a table having an open table format (OTF);
the RDBMS maintains a cache for the data stored in the table;
the RDBMS processes a query for the data stored in the table;
the RDBMS determines whether the cache is stale when processing the query using metadata for the table that is stored in the cache;
the RDBMS reads the data from the cache to process the query when the cache is not stale; and
the RDBMS incrementally updates the cache when the cache is stale, and reads the data from the cache to process the query after the cache is incrementally updated.

2. The method of claim 1, wherein the RDBMS compares the metadata stored in the cache to the metadata of the table to determine whether the cache is stale due to the table being modified by any write operation.

3. The method of claim 2, wherein the metadata for the table that is stored in the cache comprises a timestamp identifying when the cache was created or last updated, and a snapshot identifier for the metadata of the table.

4. The method of claim 3, wherein the RDBMS determines that the cache is stale when the timestamp stored in the cache is older than a timestamp associated with a current snapshot identifier for the metadata of the table.

5. The method of claim 3, wherein the RDBMS determines that the cache is stale when the snapshot identifier for the metadata of the table stored in the cache is not a current snapshot identifier for the metadata of the table.

6. The method of claim 2, wherein the metadata for the table that is stored in the cache comprises a file name for a data file and a row offset associated a row of the data file corresponding to an entry stored in the cache.

7. The method of claim 6, wherein the RDBMS determines that the entry stored in the cache is stale using a delete file that contains the file name of the data file and the row offset of the row in the data file, and the delete file indicates that the row in the data file has been updated or deleted.

8. The method of claim 7, wherein the entry stored in the cache is updated or deleted when the delete file indicates that the row in the data file has been updated or deleted.

9. The method of claim 7, wherein the delete file contains a bloom filter indicating whether a column value is present in the row.

10. The method of claim 7, wherein only the delete file is created but no new data file is created, when the row is deleted from the data file.

11. The method of claim 7, wherein the delete file and a new data file are created, when the row is updated in the data file.

12. The method of claim 7, wherein a new data file is created, when the row is inserted in the data file.

13. The method of claim 1, wherein the RDBMS triggers an asynchronous cache maintenance task after the RDBMS deletes or updates data in the table.

14. A computer-implemented apparatus, comprising:
a relational database management system (RDBMS) executing in a computer system, wherein:
the RDBMS manages a relational database storing data in a table having an open table format (OTF);
the RDBMS maintains a cache for the data stored in the table;
the RDBMS processes a query for the data stored in the table;
the RDBMS determines whether the cache is stale when processing the query using metadata for the table that is stored in the cache;
the RDBMS reads the data from the cache to process the query when the cache is not stale; and
the RDBMS incrementally updates the cache when the cache is stale, and reads the data from the cache to process the query after the cache is incrementally updated.

15. A computer program product comprising a computer readable storage medium tangibly embodying instructions accessible therefrom, the instructions executable by a computer system to cause the computer system to perform a method, comprising:
executing a relational database management system (RDBMS) in a computer system, wherein:
the RDBMS manages a relational database storing data in a table having an open table format (OTF);
the RDBMS maintains a cache for the data stored in the table;
the RDBMS processes a query for the data stored in the table;
the RDBMS determines whether the cache is stale when processing the query using metadata for the table that is stored in the cache;
the RDBMS reads the data from the cache to process the query when the cache is not stale; and
the RDBMS incrementally updates the cache when the cache is stale, and reads the data from the cache to process the query after the cache is incrementally updated.
